(19) United States
(12) Patent Application Publication
(10) Pub. No.: US 2005/0276951 A1
(43) Pub. Date: Dec. 15, 2005

(54) Foamed tile and its manufacturing method

(76) Inventors: Minoru Iwase, Nagoya-shi (JP); Katsuyoshi Koide, Nagoya-shi (JP); Yutaka Kurokawa, Nagoya-shi (JP)

Correspondence Address: FLYNN THIEL BOUTELL & TANIS, P.C., 2026 RAMBLING ROAD, KALAMAZOO, MI, 49008-1631, US

(21) Appl. No.: 11/063,233

(22) Filed: Feb. 22, 2005

(30) Foreign Application Priority Data
Jun. 15, 2004 (JP) 2004-177007

(51) Int. Cl. B32B 3/00

(52) U.S. Cl. 428/172

(57) ABSTRACT

To manufacture in thin structure, easily and at low cost. By forming a foaming glaze layer on the surface of a base material made of ceramics, the product strength is assured in a base material formed densely, and the heat insulation in the foaming glaze layer is assured, and after applying a foaming glaze on a base material or a formed body adjusted to be formed as base material, and by baking the glazed material at temperature higher than the melting and foaming point of the foaming glaze and at temperature lower than the softening temperature of the base material, dimensional changes of base layer (base material) at the time of baking are suppressed, and strict management during manufacture is not needed.

### BACKGROUND OF THE INVENTION

1. Field of the Invention

The present invention relates to a ceramic foamed tile for use in bathroom floor or wall, and its manufacturing method.

2. Description of the Related Art

Hitherto, tiles made of ceramics such as earthenware, stoneware and porcelain have been widely used in floor and wall of building because they are excellent in durability and moisture resistance as building materials, and superior in appearance and touch as decorative materials.

However, the floor and wall lined with tiles are very cold when touched in winter and not comfortable when walking with bare feet in a bathroom owing to the relation of specific heat and heat conductivity.

The present inventors have previously invented foamed ceramic products for bathroom of sinter mainly composed of SiO₂, Al₂O₃, and alkali and alkaline earth elements, this sinter consisting of a base layer having closed pores inside, and a glaze layer of substantially same composition as the base layer formed on the surface of the base layer, and a manufacturing method of foamed ceramic products for bathroom by preparing a matrix powder by mixing and crushing a ceramic material mainly composed of SiO₂, Al₂O₃, and alkali and alkaline earth elements, and a foaming agent having properties of generating gas and forming foams by reaction or decomposition during baking, shaping the matrix powder into a desired shape, glazing the substantially same composition as the matrix powder on the surface of the shaped product, and baking (see patent document 1).

The product of this invention has innumerable closed pores inside the base layer and is excellent in heat insulation owing to the gas in the pores, and hence does not feel cold when touched in winter, and it has been widely recognized as the interior material for bathroom for the sake of its comfortable feel of use.

Besides, since the upper layer is a glaze layer, it is hardly contaminated and is excellent in antifungal property, and further since the glaze layer surface is undulated, it is not slippery and is high in safety.

Patent document 1: Japanese patent publication No. 2607214 (claims)

This product of the invention has no problem in its quality, but the heat insulating section is the base layer, and this base layer must be packed with a huge quantity of heat insulating gas, and the base layer requires a sufficient thickness in order to satisfy both heat insulation and strength, and hence it is hard to form in a thin structure, it takes much expenses in storing and transporting.

In this manufacturing method, since the base layer is foamed at the time of baking, it is very difficult to control expansion and shrinkage of the base layer, and strict management is required in manufacture.

In this background, it has been a mounting demand for thin products having same or higher characteristics of the product of the invention in the aspects of heat insulation, strength, antibacterial and antifungal properties and safety, and a manufacturing method for mass production of easy control and low cost.

### SUMMARY OF THE INVENTION

The invention is intended to solve the above problems, by forming a foaming glaze layer on the surface of a base material made of ceramics, keeping the product strength by the base material formed densely, ensuring the heat resistance by the foaming glaze layer, applying a foaming glaze on the base material or formed body adjusted to form as base material, baking the glazed material at temperature higher than the melting and foaming point of the foaming glaze and at temperature lower than the softening temperature of the base material, and thereby suppressing dimensional changes of base layer (base material) at the time of baking, without requiring strict management during manufacture.

In short, in the invention, portions of the product for keeping strength and keeping heat insulation are different, and the base material can be formed densely, while a huge quantity of gas can be injected into the foaming glaze layer, and both strength and heat insulation are maintained at high levels, and the product is reduced in thickness, and expenses for storing and transporting can be saved.

After applying the foaming glaze on the base material or formed body adjusted to form as base material, the glazed material is baked at temperature higher than the melting and foaming point of the foaming glaze and at temperature lower than the softening temperature of the base material, and therefore expansion and shrinkage of base material during baking are small, and it is easy to control the dimensions, and hence the management such as composition control of base material, baking temperature and atmosphere can be simplified, and mass production is easy, which may lead to stability of product quality and reduction of manufacturing cost.

The foaming glaze contains inorganic components for generating gas by reaction or decomposition by heating, and the glaze material generates gas sufficiently when softening and melting, so that the glaze layer can securely foamed.

According to the invention as set forth in claim 2 or 10, the foaming glaze layer consists of two layers, and closed pores of large diameter are formed in the lower layer, and much gas is packed in the lower layer, and an excellent heat insulation is assured, while closed pores in the upper layer are small in diameter, and the glaze portion around the closed pores is sufficient in thickness, and if the surface of the upper layer is worn out during use, pitting due to exposure of closed pores hardly occurs, and if exposed, since the pore aperture is small, the pores are not filled with foreign matter and not contaminated.

According to the invention as set forth in claims 3, 5, 11 and 13, since the surface of the foamed tile is undulated, gaps are formed between the soles of the user and the tile surface, and the air in the gaps serves as heat insulating material, and the heat insulating effect is further improved, and at the same time since the contact surface area of the soles and tile surface is decreased, the physical cold sensation can be lessened.

At the same time, the undulation serves as slip preventive means, and the safety is enhanced.

According to the invention as set forth in claims 4 and 12, on the surface of the foamed tile, by increasing the thickness of the glaze portion of the upper side of the internally existing closed pores, pitting due to abrasion of the surface can be prevented completely.

According to the invention as set forth in claims 6, 7, 14 and 15, growth of bacteria and formation of mold in the bathroom can be prevented, and if sebum or other waste matter washed out from the body sticks to the surface of foamed tiles, the fouling components are decomposed and removed by the self-cleaning action, so that the bathroom is always kept clean and sanitary, and its practical effects are outstanding.

### DESCRIPTION OF THE PREFERRED EMBODIMENTS

The foamed tile of the invention is formed by applying a foaming glaze on a formed body of ceramic material or the surface of a base material obtained by baking the formed body, and baking the glazed material at specified temperature.

The ceramic material is not particularly specified as far as it can be sintered at ordinary temperature in a ceramic kiln, and one type or two or more types may be selected and mixed from general known ceramic materials including kaolin, pagodite, feldspar, lime, clay, silica, alumina, etc., in consideration of the plasticity in forming, fire proofness in baking, etc.

The foaming glaze contains inorganic components (foaming components) for generating gas by reaction or decomposition by heating, and the glaze material containing such foaming components includes, for example, silicon carbide, Niijima feldspar, shirasu, etc.

That is, the foaming glaze is prepared by blending the foaming material containing such foaming components, and nonfoaming general glaze material (such as frit, feldspar, talc, lime, wollastonite, clay, alumina, etc.).

By adjusting the selection, combination and blending rates of glaze material containing foaming components and general glaze material, the foaming strength of the foaming glaze can be adjusted.

The foaming glaze layer can be formed in multiple layers by using a strong foaming glaze for forming relatively large closed pores, a weak foaming glaze for forming smaller closed pores, applying the strong foaming glaze on the surface of formed body or base material, and applying the weak foaming glaze on the obtained glazed surface, and therefore the foaming glaze layer having smaller closed pores in the upper layer than the closed pores in the lower layer can be formed.

The frit of the general glaze materials is a material eluting the components in water such as borax, or components generating gas by heating such as lime, which is vitrified by fusing together with silica sand or clay, etc. so as to be easy to use as material, and generally it is mainly composed of alumina or silica, and further contains alkaline components such as sodium and potassium, alkaline earth components such as magnesium, calcium and barium, and also boric acid and others.

To improve the wear resistance of foamed tile surface, a nonfoaming general glaze may be applied on the glazed surface of the foaming glaze, or to increase the frictional coefficient of the foamed tile surface, the foaming glaze layer or nonfoaming glaze layer may be undulated.

As undulating method, a non fusible material of high fire proofness may be added in powder or granular form to the glaze for forming the surface layer of foamed tile, that is, on the foaming glaze or nonfoaming glaze, or undulations may be formed by the glaze itself by using spray or disk when applying the glaze.

Further, the antibacterial and antifungal treatment may be applied on the foamed tile surface so that the foamed tile surface may have antibacterial, antifungal or self-cleaning action, and its methods include application of commercial antibacterial or antifungal agent on the surface of foamed tile by coating or baking, or by adding antibacterial or antifungal agent to the glaze when forming the foamed tile surface.

The antibacterial or antifungal agent includes titanium oxide, silver, and zinc system, and these materials have catalytic actions for decomposing organic matter, and in particular the titanium oxide, silver and zinc system are suited to addition to the glaze because they are high in fire proofness and free from deterioration by baking.

The baking temperature of the glazed material must be higher than the melting and foaming point of the foaming glaze and lower than the softening temperature of the base material.

Further, when glazing on the formed body, and sintering and glazing the formed body simultaneously by one process of baking, the temperature must be enough for melting and foaming the foaming glaze, but also for baking the formed material to obtain a base material.

Referring now to embodiments, the invention is more specifically described below.

### Embodiment 1

In the conditions shown below, foamed tiles of the invention were manufactured, and coldness felt by the parts of body was evaluated in the samples.

Matrix of general stoneware tiles was pressed and formed into a flat plate, and the formed body was compacted and baked at 1000° C., and a tile base material was obtained.

As foaming glaze, glaze materials were blended according to Table 1 given at the end, and a proper amount of water and a slip property regulator such as deflocculant were added, and ground and mixed, a slurry of foaming glazes 1 and 2 was prepared.

On the tile base material, the foaming glaze 1 was drooped and applied in a uniform thickness on the entire surface, and foaming glaze 2 was applied on the glazed surface in undulations by using a disk device, and the obtained glazed material was baked at 1210° C. for 40 minutes.

The obtained foamed tiles were free from any defect, and coldness was not felt, evidently, as compared with stoneware tiles having general nonfoaming glaze layer.

In the foamed tile, of the foaming glaze layer, the lower layer was about 0.95 mm in thickness, about 0.75 in bulk density, and the upper layer was about 0.05 mm in thickness, and about 1.2 in bulk density.

Niijima feldspar in Table 1 (fire stone produced from Niijima, Tokyo) is known to foam itself by baking, but the foaming glaze of the embodiment does not depend on this alone, but may include silicon carbide, and the foaming strength is adjusted by varying the porosity by increasing or decreasing the blending rate by making use of carbon dioxide generated from silicon carbide by thermal reaction.

Further, by adding fusion promoting material (in this embodiment, frit, talc, wollastonite) containing components for promoting fusion of alkali, alkaline earth elements, boric acid, etc., the fusion temperature and fusion viscosity of the glaze can be lowered, and by increasing or decreasing the blending rates, the porosity is changed, and the foaming strength is adjusted.

That is, the foaming glaze 2 is higher in the blending rate of Niijima feldspar as compared with foaming glaze 1, but is lower in the blending rate of silicon carbide and fusion promoting material, and hence the foaming strength of foaming glaze 1 is stronger than that of foaming glaze 2.

In the embodiment, the glazing temperatures is set higher than the compacting and baking temperature, and this is due to the fireproof characteristic of the selected matrix and foaming glaze, and the glazing temperature is not always required to be higher, and after compacting and baking at high temperature, glazing may be executed at lower temperature.

In short, according to the method of the invention, the glazing temperature is not particularly specified as far as it is higher than the melting and foaming temperature of the foaming glaze and lower than the softening temperature of the base material.

### Embodiment 2

Same as in embodiment 1, a glazed material was composed of two layers of foaming glaze layers 1 and 2, and further a foaming glaze 2 was sprayed over, and baked in the same condition as in embodiment 1.

The obtained foamed tiles were free from any defect, and coldness was not felt, more than in embodiment 1.

Innumerable small bumps of foaming glaze 2 were formed on the surface, and the surface was rough, not slippery, and the coefficient of friction was high.

### Embodiment 3

Same as in embodiment 1, foaming glaze layers 1 and 3 were prepared, and matrix of stoneware tile was pressed and formed in a flat plate, dried and foaming glaze 1 was drooped and applied on the surface, and foaming glaze 3 was applied further by a disk device, and the obtained glazed material was baked in the same condition as in embodiment 1.

The obtained foamed tiles were free from any defect, and coldness was not felt, more than in embodiment 1.

Alumina grains of foaming glaze 3 were scattered on the surface, and the surface was rough, not slippery, and the coefficient of friction was high.

### Embodiment 4

Same as in embodiment 1, foaming glaze layers 4 and 5 were prepared, and matrix of stoneware tile was pressed and formed in a flat plate, dried, and foaming glaze 4 was drooped and applied on the surface, and foaming glaze 5 was applied further by a disk device, and the obtained glazed material was baked in the condition of 1230° C. and 24 hours.

The obtained foamed tiles were free from any defect, and coldness was not felt, more than in ordinary products.

Alumina grains of foaming glaze 5 were scattered on the surface, and the surface was rough, not slippery, and the coefficient of friction was high.

Composition of foaming glaze (wt. %)

| | Foaming glaze No. | | | | |
|---|---|---|---|---|---|
| | 1 | 2 | 3 | 4 | 5 |
| Glaze material | | | | | |
| Niijima feldspar | 81 | 84 | 84 | 85 | 88 |
| Frit | 6 | 3 | 3 | — | — |
| Talc | 3 | 3 | 3 | 2 | 2 |
| Wollastonite | 5 | — | — | 5 | — |
| Clay | 5 | 10 | 10 | 8 | 10 |
| .Silicon carbide | 0.10 | 0.06 | 0.06 | 0.10 | 0.06 |
| Alumina | — | — | 15 | — | 15 |

1. A foamed tile, being a ceramic tile for bathroom, wherein a foaming glaze layer is provided on the surface of ceramic base material, and innumerable closed pores are present in the foaming glaze layer.

2. The foamed tile of claim 1, wherein the foaming glaze layer consists of upper layer and lower layer, and closed pores in the upper layer is smaller in diameter than closed pores in the lower layer.

3. The foamed tile of claim 1, wherein undulations are formed on the surface of the foaming glaze layer.

4. The foamed tile of claim 1, wherein a nonfoaming glaze layer is formed on the foaming glaze layer.

5. The foamed tile of claim 4, wherein undulations are formed on the surface of the nonfoaming glaze layer.

6. The foamed tile of claim 1, wherein antibacterial and antifungal treatment is applied to the foaming glaze layer.

7. The foamed tile of claim 4, wherein antibacterial and antifungal treatment is applied to the nonfoaming glaze layer.

8. A manufacturing method of foamed tile, being a manufacturing method of ceramic tile for bathroom, characterized by applying a foaming glaze containing inorganic components for generating gas by reaction or decomposition by heating on the surface of ceramic base material, and baking the glazed material at temperature higher than the melting and foaming point of the foaming glaze and at temperature lower than the softening temperature of the base material.

9. A manufacturing method of foamed tile, being a manufacturing method of ceramic tile for bathroom, characterized by forming a ceramic material, applying a foaming glaze containing inorganic components for generating gas by reaction or decomposition by heating on the surface of formed body, sintering the glazed material to form the formed body into a base material, and baking at temperature higher than the melting and foaming point of the foaming glaze and at temperature lower than the softening temperature of the base material.

10. The manufacturing method of foamed tile of claim 8, wherein the foaming glaze is composed of strong foaming glaze and weak foaming glaze, and application of strong foaming glaze is followed by application of weak foaming glaze.

11. The manufacturing method of foamed tile of claim 8, wherein undulations are formed on the glazed surface of the foaming glaze.

12. The manufacturing method of foamed tile of claim 8, wherein application of foaming glaze is followed by application of nonfoaming glaze thereon.

13. The manufacturing method of foamed tile of claim 12, wherein undulations are formed on the glazed surface of the nonfoaming glaze.

14. The manufacturing method of foamed tile of claim 8, wherein antibacterial and antifungal agent composed of catalyst such as titanium oxide system, silver system, or zinc system is added to the foaming glaze.

15. The manufacturing method of foamed tile of claim 12, wherein antibacterial and antifungal agent composed of catalyst such as titanium oxide system, silver system, or zinc system is added to the nonfoaming glaze.
